(19) United States
(12) Patent Application Publication
(10) Pub. No.: US 2010/0324207 A1
(43) Pub. Date: Dec. 23, 2010

(54) PHOTOVOLTAIC MODULE MONO-BACKSHEET, METHOD FOR THE PRODUCTION THEREOF, AND THE USE THEREOF IN THE PRODUCTION OF PHOTOVOLTAIC MODULES

(75) Inventors: André STURZEL, Igis (CH); Georg STOEPPELMANN, Bonaduz (CH); Dietmar ETZEL, Niederurnen (CH); Botho HOFFMANN, Domat/ Ems (CH)

Correspondence Address: GREENBLUM & BERNSTEIN, P.L.C., 1950 ROLAND CLARKE PLACE, RESTON, VA, 20191, US

(73) Assignee: EMS-PATENT AG, Domat/Ems (CH)

(21) Appl. No.: 12/817,823

(22) Filed: Jun. 17, 2010

(30) Foreign Application Priority Data
Jun. 18, 2009 (EP) 09 163 070.7

(51) Int. Cl. C08L 67/00; C08G 63/00; C08G 69/14; C08G 73/00; C08L 79/00; B29C 47/00

(52) U.S. Cl. 524/606; 528/272; 528/323; 528/363; 528/422; 524/599; 524/612; 264/473; 264/470

(57) ABSTRACT

Relates to mono-backsheets for photovoltaic modules. These mono-backsheets are produced or producible from a molding compound, this molding compound being based on at least one polyamide. The photovoltaic module mono-backsheet according to the invention is characterized in that the at least one polyamide is synthesized from linear and/or branched aliphatic and/or cycloaliphatic monomers, which have an average of at least 8 and at most 17 carbon atoms. The monomers are selected from the group which comprises diamines, dicarboxylic acids, lactams, and amino carboxylic acids, as well as mixtures thereof. The polyamides PA 610 and PA 612 are excluded from the present invention, and the polyamides based on lactams and amino carboxylic acids are cross-linked.

### RELATED PATENT APPLICATIONS

This patent application claims priority of the European patent application No. EP 09 163 070.7 filed on Jun. 18, 2009, the entire disclosure of which is incorporated herein be explicit reference for all intents and purposes.

### FIELD OF TECHNOLOGY

The invention relates to photovoltaic modules, i.e., solar cell modules for photoelectric power generation. In such a photovoltaic module, a number of individual solar cells are assembled on a surface and interconnected. Modules having only one solar cell are also possible. The solar cells are thin discs made of semiconductor material, which discharge an electrical voltage upon exposure and thus convert the incident sunlight directly into electrical power. Silicon is primarily used as the semiconductor material for this purpose. Many modules are connected in series in larger photovoltaic solar plants, which results in high electrical plant voltage and power.

A photovoltaic module is typically constructed in tabular form as a laminate: a transparent pane is situated uppermost, for example, made of special glass. An adhesion-mediating sheet, preferably made of ethylene vinyl acetate (EVA) adjoins underneath, which is to connect the transparent pane to the actual solar cells (multiple silicon discs or also only one single silicon disc). A further adhesion-mediator sheet (EVA) connects the lower sides of the solar cells to a some-what thicker backsheet, which represents the rear protective layer of the module. The composite of these layers is thermally compacted in a vacuum press (so that the layers stick to one another via the EVA upon hot compression). The layer materials are firstly laid in reverse sequence in the press, so that the glass pane can be used as a rigid underlay for the other layers during the lamination. In this way, the solar cells are embedded in the elastic and transparent EVA hot melt adhesive, and encapsulated between the glass and the backsheet. The backsheet of such a photovoltaic module is the main subject matter of the present invention.

### RELATED PRIOR ART DOCUMENTS

A good description of this technological background is provided by International Patent Application WO 94/22172. Tedlar® (trademark of E. I. du Pont de Nemours and Company), a sheet made of polyvinyl fluoride (PVF), is listed therein as the preferred backsheet. The Tedlar® backsheet is typically used in practice in the form of a three-layer sheet (PVF/PET/PVF). WO 94/22172 discloses still further thermoplastics such as polyolefins, polyesters, diverse polyamides (nylons), polyetherketones, fluoropolymers, etc. as possible materials for the rear module layer.

The use of polyamide as an encapsulation material for photovoltaic modules is at the center of International Patent Application WO 2008/138021 A2. This document refers in the introduction to the prior art having the multilayer sheet composites made of fluoropolymers and polyesters (i.e., PVF and PET) as the (rear) encapsulation material. Because the adhesion of this encapsulation material to the embedding material, the ethylene vinyl acetate (EVA), is slight, polyamide (PA) is proposed as the encapsulation material, i.e., as the material for use in backsheets of photovoltaic modules in WO 2008/138021 A2. Various polyamide types are explicitly listed: PA 6, PA 66, PA 7, PA 9, PA 10, PA 11, PA 12, PA 69, PA 610, PA 612, PA 6-3-T, PA 6I, and polyphthalamide (PPA). The suitability of the listed PA types is not experimentally proven for use in a sheet composite or as a mono-sheet in the document WO 2008/138021 A2, however.

Polyamide 11 is also noted as a possible backsheet material in the technical article “Bio Based Backsheet” by S. B. Levy, which appeared in Proc. of SPIE (2008) Vol. 7048 (Reliability of Photovoltaic Cells, Modules, Components, and Systems), 70480C/1-10. In this article, nylon 11 (or PA 11) is viewed as a reasonable material for backsheets, because it is based on a renewable raw material source (castor oil). Furthermore, it is disclosed that PA 11 is nonetheless resistant (i.e., it is not biologically degraded), and it is thus of interest for use in environmentally-friendly solar power generation. Moreover, it is disclosed that in practice nylon 11 was not used alone, but rather always in the composite with another sheet material (e.g., cellulose) as the backsheet.

US 2009/0101204 A1, in which S. B. Levy is also named as the first inventor, also comes to the same conclusion. The polyamide 11 (nylon-11 layer 510) is used here in the composite with a special, electrically insulating paper (505) as a photovoltaic backsheet (500) (cf. FIG. 5 and corresponding explanations). The polyamide 11 is applied by extrusion coating to the paper.

WO 2008/138022 A1 also describes polyamide 12 as a layer material for protective sheets of photovoltaic modules and additionally indicates that these sheet composites primarily comprise a carrier material layer selected from polyester (PET or PEN) or the fluoropolymer ETFE.

### OBJECTS AND SUMMARY OF THE PRESENT INVENTION

In contrast to the prior art, which typically provides multilayered backsheets, the present invention is based on the object of finding suitable polyamides, on the basis of which single-layer backsheets (mono-sheets) for photovoltaic modules may be produced.

This object is achieved by a backsheet based on polyamide having the features as defined herein. Preferred embodiments are disclosed in the subclaims. In addition, a method for producing such backsheets is claimed, and the use thereof for producing photovoltaic modules.

The object is achieved according to the invention by a backsheet which is produced as a mono-sheet from a molding compound based on polyamide, the polyamide being synthesized based on linear and/or branched aliphatic and/or cycloaliphatic monomers, selected from the group comprising diamines, dicarboxylic acids, lactams, and amino carboxylic acids in such a manner that the monomers have at least 8 and at most 17 carbon atoms on average, polyamide 610 and polyamide 612 being excluded, and the polyamides based on lactams and amino carboxylic acids being cross-linked.

### DESCRIPTION OF THE PRESENT INVENTION

In other words: The invention relates to mono-backsheets for photovoltaic modules. These mono-backsheets are produced or producible from a molding compound, this molding compound being based on at least one polyamide. The photovoltaic module mono-backsheet according to the invention is characterized in that the at least one polyamide is synthesized from linear and/or branched aliphatic and/or cycloaliphatic monomers. The monomers selected for the polyamide have an average of at least 8 and at most 17 carbon atoms (i.e., individual monomers may have fewer than 8 carbon atoms, if the other monomers contained in the polyamide accordingly have more than 8 carbon atoms to make up for this).

The fact that the monomers selected for the polyamide have an average of at least 8 and at most 17 carbon atoms expands the selection palette for individual monomers downward (compared to the stricter condition that each monomer contained in the polyamide must have at least 8 carbon atoms) and is based on the consideration that possibly short monomers (e.g., short-chain diamines) may be compensated or overcompensated for using longer monomers of the other type (e.g. long-chain dicarboxylic acids) in the same polyamide so that the average of at least 8 carbon atoms (and at most 17 carbon atoms) results. An example of a polyamide in which the average requirement is fulfilled, but every monomer does not have at least 8 carbon atoms, is PA 412, which is synthesized from the C4-diamine butane diamine and the C12-dicarboxylic acid dodecane diacid

The monomers are selected from the group comprising diamines, dicarboxylic acids, lactams, and amino carboxylic acids and mixtures thereof. In addition, the following conditions apply (for delimitation from the prior art): the polyamides PA 610 and PA 612 are excluded from the present invention and, on the other hand, the polyamides based on lactams and amino carboxylic acids are cross-linked.

The polyamides based on diamines and dicarboxylic acids from the listed range represent preferred variants in both non-cross-linked and also cross-linked form.

The polyamide can also contain cycloaliphatic monomers in addition to aliphatic monomers, of which the following are preferred: CHDA (abbreviation for the cycloaliphatic monomer compound cyclohexane dicarboxylic acid, 1,4-CHDA being meant), BAC (abbreviation for bisaminocyclohexane), PACM (=4,4′-diaminodicyclohexyl-methane), MACM (=3,3′-dimethyl-4,4′-diaminodicyclohexylmethane), and mixtures of the cycloaliphatic diamines.

In preferred embodiments, the polyamide is selected from the group comprising polyamide 4X (X=linear aliphatic dicarboxylic acid having 12 to 18 carbon atoms), polyamide 4X cross-linked, polyamide 9 cross-linked, polyamide 99, polyamide 99 cross-linked, polyamide 910, polyamide 910 cross-linked; polyamide 1010, polyamide 1010 cross-linked, polyamide 11 cross-linked, polyamide 12 cross-linked, polyamide 1010/10CHDA, polyamide 1010/10CHDA cross-linked, polyamide 610/10CHDA, polyamide 610/10CHDA cross-linked, polyamide 612/10CHDA, polyamide 612/10CHDA cross-linked, polyamide 910/10CHDA, polyamide 910/10CHDA cross-linked, polyamide 912/10CHDA, polyamide 912/10CHDA cross-linked, polyamide 1012/10CHDA, polyamide 1012/10CHDA cross-linked, polyamide 610/12CHDA, polyamide 610/12CHDA cross-linked, polyamide 612/12CHDA, polyamide 612/12CHDA cross-linked, polyamide 910/12CHDA, polyamide 910/12CHDA cross-linked, polyamide 912/12CHDA, polyamide 912/12CHDA cross-linked, polyamide 1012/12CHDA, polyamide 1012/12CHDA cross-linked, polyamide 1212/12CHDA, polyamide 1212/12CHDA cross-linked, polyamide 1212/10CHDA, polyamide 1212/10CHDA cross-linked, polyamide 1012, polyamide 1012 cross-linked, polyamide 1014, polyamide 1014 cross-linked, polyamide 1212, polyamide 1212 cross-linked, polyamide 1210, polyamide 1210 cross-linked, polyamide MACMY (Y=linear aliphatic dicarboxylic acid having 9 to 18 carbon atoms), polyamide MACMY cross-linked, polyamide PACMY, polyamide PACMY cross-linked, polyamide MACMY/PACMY, polyamide MACMY/PACMY cross-linked, and mixtures thereof.

The polyamide is particularly preferably selected from the group comprising polyamide 1010 and polyamide 1010 cross-linked.

The generic term polyamide (abbreviated as PA) is also understood to include homopolyamides, copolyamides, and mixtures (blends) of homopolyamides and/or copolyamides.

The polyamide molding compound of the backsheet according to the invention preferably contains at least one additive, selected from white pigments, UV stabilizers, UV absorbers, antioxidants, heat stabilizers, hydrolysis stabilizers, cross-linking activators, flame retardants, layered silicates, fillers, colorants (comprising dyes and color pigments), reinforcing agents, adhesion mediators, impact strength modifiers, and fluoropolymers.

Through the selection of the polyamide from the claimed range, and the optional addition of one or more of these additives, the polyamide photovoltaic module mono-backsheet according to the invention, in a particularly preferred embodiment and in a single layer, fulfills all essential requirements for such a backsheet, such as weathering stability (UV and hydrolysis resistance), heat resistance, mechanical protection, electrical insulation, high reflectivity, and good adhesion.

The white pigment, which provides the desired high reflectivity, is preferably titanium dioxide (e.g., in the rutile or anatase crystal modification). Titanium dioxide simultaneously also acts as a UV absorber. Other possible white pigments are zinc oxide and zinc sulfide, for example. The reflectivity of the backsheet achieved using white pigments is preferably at least 92%.

The method of extrusion is best applied for producing the photovoltaic module mono-backsheet according to the invention. If cross-linking of the polyamide is to be achieved, a cross-linking activator is added to the polyamide molding compound before the molding. Preferred cross-linking activators are, for example, TMPTMA (=trimethylol propane trimethacrylate) and TAIC (=triallyl isocyanurate). The cross-linking can already be performed during the compounding or sheet extrusion in-line in a radical manner with a corresponding activator. However, the cross-linking is preferably triggered afterward on the extruded sheet by high-energy irradiation. The high-energy irradiation is preferably performed by electron irradiation.

The backsheet thus produced of the composition according to the invention is used for producing photovoltaic modules.

The variants having the cross-linked polyamide 11 and the polyamide 910 (non-cross-linked and cross-linked), the polyamide 1010 (non-cross-linked and cross-linked), the polyamide 1010/10CHDA (non-cross-linked and cross-linked), the polyamide 1012 (non-cross-linked and cross-linked), and the polyamide 1210 (non-cross-linked and cross-linked) may additionally assert the ecological argument that they are based on a renewable raw material, because castor oil is not only the starting base for producing the PA 11 monomer, but rather also for sebacic acid (decane diacid) and decane diamine, which are used for synthesizing polyamides having the C10 diacid and/or C10 diamine. In addition, azelaic acid (i.e., the C9 diacid) is also accessible from castor oil, which occurs in PA 99 or PA (M and/or P)ACM 9.

The invention is explained in greater detail hereafter on the basis of examples and comparative examples. It is obvious that some of the polyamides listed in WO 2008/138021 A2 do not fulfill all requirements for use as the mono-backsheet. Even without comparative experiments, it can be stated that, for example, polyamide 6 and polyamide 66 do not come into consideration because of their high water absorption. Partially aromatic polyamides such as polyphthalamide (PPA) are unsuitable, because aromatic monomers are not UV-resistant. On the other hand, normal polyamide 11 and polyamide 12 have the problem that their melting point is only slightly above the lamination temperature during the module production in a vacuum press. This processing problem may be mitigated by cross-linking, i.e., higher lamination temperatures may be applied without the polyamide beginning to flow away. In addition, the resistance, i.e., the lifetime of the backsheet in outside use, can be increased by cross-linking.

The following materials were used in the performed experiments designated as examples and comparative examples according to Tables 1 through 4:
PA12: polyamide 12 (ηᵣₑₗ=1.85), EMS-CHEMIE AG, Switzerland
PA 612: polyamide 612 (ηᵣₑₗ=1.80), EMS-CHEMIE AG, Switzerland
PA1010: polyamide 1010 (ηᵣₑₗ=1.92), EMS-CHEMIE AG, Switzerland
   (relative viscosity ηᵣₑₗ measured in each case according to the method specified hereafter)
antioxidant 1: ethylene bis(oxyethylene)bis[3-(5-tert-butyl-4-hydroxy-m-tolyl)propionate]
   antioxidant based on a sterically hindered phenol
antioxidant 2: tetrakis(2,4-di-tert-butylphenyl)-[1,1-biphenyl]-4,4′-diylbisphosphonite
   antioxidant based on phosphonite
UV absorber: N-(2-ethoxyphenyl)-N′-(2-ethylphenyl)oxamide
UV/heat stabilizer: N,N′-Bis-2,2,6,6-tetramethyl-4-piperidinyl-1,3-benzoldicarboxamide
TiO₂: titanium dioxide, rutile type
TMPTMA: trimethylol propane trimethacrylate, cross-linking activator

The molding compounds of the compositions according to Table 1 were produced on a double-screw extruder of type ZSK 25 from Werner u. Pfleiderer. The particular polyamide granules were dosed together with the stabilizers into the intake, and the titanium dioxide was dosed using a side conveyor into the melt. The cross-linking activator is preferably dosed using a pump into a zone, which is still cold, after the intake.

The housing temperature was set as a rising profile up to 270° C. At a screw speed of 200 RPM (rotations per minute), 12 kg throughput per hour was achieved. The granulation was performed using strand granulation. After drying at 80° C. for 24 hours, the granule properties were measured and flat sheets were produced.

The flat sheets were produced on a Collin laboratory facility, type 3300, 3-zone screw having 30 mm diameter, L/D ratio=25. Chill-roll type 136/350. The cylinder temperatures and die temperatures are described in Table 1. The width of the sheets was 300 mm and the thickness was 300 μm (=0.3 mm). Impact-tensile test specimens in the form according to DIN 53448 were cut from these sheets using water jet cutting.

In the case of variants having cross-linking activator, the electron beam cross-linking was performed on sheets which had been cut to a DIN A4 format. The acceleration voltage was 10 MeV, and the dose was 125 kGy.

The heated storage was performed in circulating air furnaces at 80° C., 100° C., and 120° C. according to ISO 2578/IEC216-1.

Weathering tests were performed in a Weatherometer weathering device type CI4000 under the following conditions: irradiation power 0.50 W/m², cycle 102/18 minutes (dry/raining). The black body temperature was 65° C.±3° C., the humidity was 65%±5%.

The tensile impact strength (DIN 53448) and color difference Δ_{E}D65 (DIN 6174) (i.e., the color worsening) were measured as a criterion for the temperature and weather resistance.

Relative viscosity ηᵣₑₗ: according to EN ISO 307 (2003), measured on a solution of 0.5 wt.-% polyamide in m-cresol (i.e., 0.5 g polyamide in 100 ml solution) at a temperature of 25° C. As defined, ηᵣₑₗ=η/η₀ (viscosity of the solution divided by the viscosity of the solvent).

MVR (melt volume rate): melt flow index expressed in the unit cm³/10 min and measured according to ISO 1133 at 275° C. and a load of 5 kg.

PA 612 was used as a comparative example according to the prior art (designated as V1 in the following tables), while the examples according to the invention were designated by E1 (corresponding to PA 1010), E2 (PA 1010 cross-linked), and E3 (PA 12 cross-linked).

Table 1 shows a list of the performed experiments in the particular composition of the materials and machine parameters used.

TABLE 1

| | experiment | | | |
|---|---|---|---|---|
| | V1 | E1 | E2 | E3 |
| | (PA 612) | (PA 1010) | (PA 1010 v.) | (PA 12 v.) |
| composition | [wt.-%] | [wt.-%] | [wt.-%] | [wt.-%] |
| PA 12 | | | | 85.4 |
| PA 612 | 88.4 | | | |
| PA 1010 | | 88.4 | 85.4 | |
| TMPTMA | | | 3.0 | 3.0 |
| antioxidant 1 | 0.6 | 0.6 | 0.6 | 0.6 |
| antioxidant 2 | 0.2 | 0.2 | 0.2 | 0.2 |
| UV absorber | 0.5 | 0.5 | 0.5 | 0.5 |
| UV/heat stabilizer | 0.3 | 0.3 | 0.3 | 0.3 |
| TiO₂ | 10.0 | 10.0 | 10.0 | 10.0 |
| MVR [cm³/10 min] | 150 | 40 | 45 | 90 |
| ηᵣₑₗ [0.5%, m-cresol] | 1.799 | 1.915 | 1.911 | 1.874 |
| cylinder temperature | 210-230 | 220-245 | 220-245 | 210-230 |
| [° C.] | | | | |
| die temperature [° C.] | 220-240 | 240 | 240 | 230 |

Table 2 shows the change of the tensile impact strength and color during the furnace storage at 80° C.

TABLE 2

| | | | | |
|---|---|---|---|---|
| furnace storage 80° C. | V1 | E1 | E2 | E3 |

| | |
|---|---|
| Time [h] | Tensile impact strength [kJ/m²] |

| | | | | |
|---|---|---|---|---|
| 0 | 33 | 68 | 57 | 41 |
| 288 | 32 | 52 | 48 | 39 |
| 750 | 27 | 49 | 38 | 39 |
| 1488 | 33 | 45 | 41 | 37 |
| 2496 | 28 | 37 | 25 | 40 |

| | |
|---|---|
| Time [h] | Color difference |

| | | | | |
|---|---|---|---|---|
| 0 | 0 | 0 | 0 | 0 |
| 288 | 1.0 | 0.7 | 1.9 | 1.8 |
| 750 | 3.7 | 1.5 | 2.5 | 3.1 |
| 1488 | 5.2 | 1.9 | 3.4 | 4.1 |
| 2496 | 6.6 | 2.4 | 3.9 | 4.9 |

Table 3 shows the change of the tensile impact strength and color during the weathering in the Weatherometer.

TABLE 3

| | | | | |
|---|---|---|---|---|
| weathering | V1 | E1 | E2 | E3 |

| | |
|---|---|
| Time [h] | Tensile impact strength [kJ/m²] |

| | | | | |
|---|---|---|---|---|
| 250 | 41 | 64 | 58 | 40 |
| 750 | 38 | 56 | 39 | 32 |
| 1500 | 37 | 64 | 44 | 35 |
| 2250 | 28 | 56 | 34 | 31 |
| 3000 | 24 | 45 | 29 | 31 |

| | |
|---|---|
| Time [h] | Color difference |

| | | | | |
|---|---|---|---|---|
| 0 | 0 | 0 | 0 | 0 |
| 250 | 1.5 | 0.4 | 0.5 | 0.4 |
| 750 | 2.0 | 0.8 | 0.8 | 0.7 |
| 1500 | 2.2 | 1.5 | 0.6 | 0.7 |
| 2250 | 2.3 | 1.6 | 0.3 | 0.3 |
| 3000 | 3.8 | 2.1 | 2.0 | 2.5 |

### Test of the Composite Adhesion:

Sheets produced in the A4 format of the experimental variants were cleaned using ethanol, compressed in the layer construction polyamide sheet 0.3 mm/EVA hot melt adhesive sheet for solar modules 0.5 mm/polyamide sheet 0.3 mm in a heatable press between two metal plates, beginning from room temperature up to 140° C. in 10 minutes, 5 minutes holding time, and cooled to room temperature within 10 minutes, the upper 35 mm between the polyamide sheets being insulated by anti-adhesive paper.

After 24 hours, the sheet composite was cut into strips of 20 mm width and 155 mm length. The cut sheets were rapidly conditioned at 70° C. and 62.5% ambient humidity for 1 week. After cooling to room temperature, the tensile strength of the sheet composite was tested with respect to layer separation after a further 24 hours.

The polyamide sheets provided unglued at the upper edge were used for chucking in a tensile testing machine. Testing was performed at a speed of 50 mm/minute. The highest traction force Fₘₐₓ for separating the composite was measured as an average value, which is to be greater than 40 N/cm for the application according to the invention.

Table 4 shows an overview of the composite adhesion polyamide sheet/EVA sheet for solar modules/polyamide sheet.

TABLE 4

| | polyamide sheet material | | | |
|---|---|---|---|---|
| | | | E2 (PA 1010 | E3 (PA 12 |
| | V1 (PA 612) | E1 (PA 1010) | cross-linked) | cross-linked) |
| Fₘₐₓ [N/cm] | 40 | 74 | 53 | 48 |
| mean value | | | | |

The experiments have shown that the variants according to the invention fulfill the requirements and have significantly better properties and resistances than the comparative variant V1 (PA 612), which corresponds to the prior art according to WO 2008/138021 A2. In particular, the particularly preferred variants E1 and E2 using PA 1010 and PA 1010 cross-linked have displayed unexpectedly good results.

1. A photovoltaic module mono-backsheet produced from a molding compound based on at least one polyamide,
wherein the at least one polyamide is synthesized from linear and/or branched aliphatic and/or cycloaliphatic monomers, which have an average of at least 8 and at most 17 carbon atoms and which are selected from the group comprising diamines, dicarboxylic acids, lactams, and amino carboxylic acids and mixtures thereof,
polyamide 610 and polyamide 612 being excluded, and the polyamides based on lactams and amino carboxylic acids being cross-linked.

2. The photovoltaic module mono-backsheet according to claim 1,
wherein the polyamides based on diamines and dicarboxylic acids are non-cross-linked or cross-linked.

3. The photovoltaic module mono-backsheet according to claim 1, wherein in addition to aliphatic monomers, the polyamide contains cycloaliphatic monomers, which are selected from the group CHDA, BAC, PACM, MACM and mixtures of the cycloaliphatic diamines.

4. The photovoltaic module mono-backsheet according to claim 1,
wherein the polyamide is selected from the group comprising polyamide 4X, polyamide 4X cross-linked, polyamide 9 cross-linked, polyamide 99, polyamide 99 cross-linked, polyamide 910, polyamide 910 cross-linked, polyamide 1010, polyamide 1010 cross-linked, polyamide 11 cross-linked, polyamide 12 cross-linked, polyamide 1010/10CHDA, polyamide 1010/10CHDA cross-linked, polyamide 610/10CHDA, polyamide 610/10CHDA cross-linked, polyamide 612/10CHDA, polyamide 612/10CHDA cross-linked, polyamide 910/10CHDA, polyamide 910/10CHDA cross-linked, polyamide 912/10CHDA, polyamide 912/10CHDA cross-linked, polyamide 1012/10CHDA, polyamide 1012/10CHDA cross-linked, polyamide 610/12CHDA, polyamide 610/12CHDA cross-linked, polyamide 612/12CHDA, polyamide 612/12CHDA cross-linked, polyamide 910/12CHDA, polyamide 910/12CHDA cross-linked, polyamide 912/12CHDA, polyamide 912/12CHDA cross-linked, polyamide 1012/12CHDA, polyamide 1012/12CHDA cross-linked, polyamide 1212/12CHDA, polyamide 1212/12CHDA cross-linked, polyamide 1212/10CHDA, polyamide 1212/10CHDA cross-linked, polyamide 1012, polyamide 1012 cross-linked, polyamide 1014, polyamide 1014 cross-linked, polyamide 1212, polyamide 1212 cross-linked, polyamide 1210, polyamide 1210 cross-linked, polyamide MACMY, polyamide MACMY cross-linked, polyamide PACMY, polyamide PACMY cross-linked, polyamide MACMY/PACMY, polyamide MACMY/PACMY cross-linked, and mixtures thereof,
in which:
designates a linear aliphatic dicarboxylic acid having 12 to 18 carbon atoms, and
Y designates a linear aliphatic dicarboxylic acid having 9 to 18 carbon atoms.

5. The photovoltaic module mono-backsheet according to claim 4,
wherein the polyamide is selected from the group polyamide 1010 and polyamide 1010 cross-linked.

6. The photovoltaic module mono-backsheet according to claim 1,
wherein the polyamide molding compound contains at least one additive, which is selected from a group which consists of white pigments, UV stabilizers, UV absorbers, antioxidants, heat stabilizers, hydrolysis stabilizers, cross-linking activators, flame retardants, layered silicates, fillers, colorants, reinforcing agents, adhesion mediators, impact strength modifiers, and fluoropolymers.

7. The photovoltaic module mono-backsheet according to claim 6,
wherein the white pigment is titanium dioxide.

8. The photovoltaic module mono-backsheet according to claim 6,
wherein it contains a white pigment and has a reflectivity of at least 92%.

9. A method for producing a photovoltaic module mono-backsheet from a moulding compound based on at least one polyamide according to claim 1,
wherein this polyamide molding compound is extruded, the at least one polyamide being synthesized from linear and/or branched aliphatic and/or cycloaliphatic monomers, which have an average of at least 8 and at most 17 carbon atoms and which are selected from the group comprising diamines, dicarboxylic acids, lactams, and amino carboxylic acids and mixtures thereof,
polyamide 610 and polyamide 612 being excluded, and the polyamide based on lactams and amino carboxylic acids being cross-linked.

10. The method for producing a photovoltaic module mono-backsheet according to claim 9,
wherein, to achieve cross-linking of the polyamide, a cross-linking activator is added to the polyamide molding compound before the molding.

11. The method for producing a photovoltaic module mono-backsheet according to claim 10,
wherein a sheet is extruded and the cross-linking is triggered on the extruded sheet by high energy radiation.

12. The method for producing a photovoltaic module mono-backsheet according to claim 11,
wherein the high-energy irradiation is performed by electron irradiation.

13. The method for producing a photovoltaic module mono-backsheet according to claim 10,
wherein the cross-linking activator is selected from the group trimethylol propane trimethacrylate and triallyl isocyanurate.
